(19) United States
(12) Patent Application Publication
(10) Pub. No.: US 2005/0183048 A1
(43) Pub. Date: Aug. 18, 2005

(54) Method to simulate the influence of production-caused variations on electrical interconnect properties of semiconductor layouts

(76) Inventor: Harald Kinzelbach, Muenchen (DE)

Correspondence Address: SLATER & MATSIL LLP, 17950 PRESTON ROAD, SUITE 1000, DALLAS, TX, 75252, US

(21) Appl. No.: 11/044,625

(22) Filed: Jan. 27, 2005

(30) Foreign Application Priority Data
Jan. 30, 2004 (DE) 10 2004 005 008.2

(51) Int. Cl. G06F 17/50

(52) U.S. Cl. 716/4; 703/14

(57) ABSTRACT

A method is provided to simulate the influence of production-caused variations of interconnect properties in modern semiconductor-technology layouts. Fluctuations of the physical interconnect properties are extracted from a given layout where the geometric layout data and the corresponding technology characteristics serve as input parameters. Statistical distribution of characteristic interconnect properties are the resulting output. If the fluctuations of the interconnect properties or the resulting fluctuations in the system performance meet the specifications, the layout is accepted, otherwise it has to be rejected.

This application claims priority to German Patent Application 10 2004 005 008.2, which was filed Jan. 30, 2004, and is incorporated herein by reference.

### TECHNICAL FIELD

The present invention relates to a method for simulation in semiconductor technology, particularly to a method to simulate the influence of production-caused variations on characteristic layout interconnect properties.

### BACKGROUND

Usually in semiconductor production circuit designs given in the form of layout and technology data are subject to extensive simulations already in early development stages, long before the actual production process starts, to test the manufacturability and performance of the designed circuits. One of these simulation steps is to model the (parasitic) interconnect properties of the given complicated layout structures, and to include this data in the performance simulations to make sure that these parasitic interconnect properties do not spoil the final functional behavior of the system.

In what follows, the expression “interconnect parameters” in general denotes parasitic resistances and capacitances (and possibly inductances) that are physical properties of the interconnection lines defined in the layout to connect the designed semiconductor devices. In the current nanometer technologies, these (parasitic) physical properties of the circuit interconnect have a significant influence on the actual system performance and can no longer be neglected in the circuit simulations performed to assess the quality and functionality of the design long before the actual production starts.

To derive reliable models for the physical interconnect properties corresponding to a given layout design, the layout data and the data of all relevant material properties are transferred to a special simulation tool, called a layout-extractor, which derives the (parasitic) physical interconnect properties of the usually large number of physical interconnect structures defined in the given layout design. This layout extraction usually is a very complex mathematical problem, and accordingly also the computer related extraction process itself is of considerable complexity since the physical interconnect properties of any given element usually depends, in a complicated and nonlinear fashion, on the given input data and the other elements found in the same layout. Nevertheless, it is meanwhile necessary, and a standard procedure, to include the extracted interconnect data in the pre-production simulations to achieve sufficiently reliable results.

With ever decreasing feature size and increasing design complexity, however, the influence of unavoidable random variations in the manufacturing process is found to be of strongly increasing relevance. Among other things, these fluctuations also lead to deviations between the interconnect properties seen in the final product and those expected from the ideal layout extraction process.

The interconnect properties themselves more and more become randomly fluctuating quantities, and to achieve a sufficient simulation accuracy in the pre-production phase, these fluctuations have to be taken into account as early as possible.

Since the extraction and simulation process itself is a very complex and time consuming effort, however, it is hardly possible to simply repeat it for a large number of randomly chosen layout and technology data. It is, therefore, mandatory to use some more efficient approaches to cope with this difficulty.

### SUMMARY OF THE INVENTION

In one aspect, the present invention increases the efficiency of the extraction and simulation process, avoiding the disadvantages of the above-mentioned approaches. In another aspect, the present invention improves the accuracy and reliability of the corresponding results.

The preferred embodiment of the present invention relates to a method to model the influence of production variations on interconnect properties with sufficient accuracy while effectively limiting the number of necessary simulation steps.

For this method, a layout and the related material characteristics, as well as the probability distribution of the production variations that modify these input data are given. The original layout and technology data are passed to a layout extractor, which generates a list of nominal interconnect parameters representing the interconnect-structure and interconnect-properties of the original design. Such a list is called an “interconnect netlist.”

In subsequent steps, this standard procedure is repeated, but now with input parameters, which are varied within the scope of the probability distribution of the input variations in each repetition. The procedure yields a set of different interconnect netlists.

In a configuration of the inventive method, the numerical values contained in the interconnect netlists are transformed to optimize the following approximation procedure.

In a favorable configuration this transformation comprises a simple linear transformation to ensure a convenient normalization of the netlist entries. In another favorable configuration the transformation uses a logarithmic function to map the original netlist entries to a new range of values.

In a subsequent step, the original interconnect netlist is compared with the netlists generated using the modified input parameters, and the dependency of the interconnect parameters from the variation of these input parameters is quantitatively modeled using a linear approximation based on the corresponding local gradients. The approximation correctly represents the change of the various interconnect parameters as induced by fluctuations of the input parameters, it also correctly covers correlations between the changes of the different interconnect parameters which are due to the fact that these parameters depend on the same changing input data.

In a configuration of the invention, the derived explicit functional dependence is used to generate a representative set of random realizations of the interconnect parameters by inserting randomly fluctuating values of the input quantities and tracking the resulting interconnect parameter results. This generated set of random interconnect configurations, which also correctly reflects the correlations between the resulting values, can be used to assess the typical random fluctuations of the interconnect parameters. This may serve as a base for the decision whether the given layout can be produced with the necessary yield or has to be rejected.

In a particularly favorable configuration of the invention, the explicit functional dependence derived above is used to calculate an explicit expression for the full probability distribution of the interconnect parameters induced by the input fluctuations. Using this probability distribution, the number of layout variations which violate the original specifications due to process variations, and the boundary of the fluctuation region to be expected can be calculated.

If these results are acceptable with respect to the original tolerance specifications, the given layout design can be accepted. Otherwise it has to be rejected.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a two-dimensional cross section through a simple bus structure as an illustrative example for possible layout data;

FIGS. 2a-2c illustrate the distribution of the parameters for the simple case of a system described by only two interconnect parameters R, C, where FIG. 2a shows the R, C distribution induced by production variations, FIG. 2b shows the contour-lines of a simple histogram-approximation resulting from FIG. 2a, and FIG. 2c shows the contour-lines of the corresponding distribution determined by the inventive method;

FIG. 3 shows the contour-lines of the probability distribution of the interconnect parameters which results from the inventive method (again for the simple case of a system described by only two interconnect parameters R, C), and some illustrative corner-cases which are used to characterize the fluctuation region and which may serve as decision criteria;

FIG. 4 illustrates a schematic overview of a first favorable implementation of the inventive method; and

FIG. 5 illustrates a schematic overview of a second favorable implementation of the inventive method.

### SIGNS AND SYMBOLS

x vector of the input parameters consisting of (x₁, . . . , x_{K})
K number of the input parameters
Q covariance matrix of the input parameters
w(x) probability distribution of the input parameters
Γ list of interconnect parameters consisting of (g₁, . . . , g_{N})
g interconnect parameter
N number of interconnect parameters
Γ₀ netlist of nominal interconnect parameters
φ(g) transformation function for the interconnect parameters
G list of transformed interconnect parameters consisting of (γ₁ . . . γ_{N})
γtransformed interconnect parameter
Ωmatrix of local gradients of G
P(Γ) probability density of the original interconnect parameters (without any variable transformation)
p(γ) probability density of the transformed interconnect parameters
\tilde{p}(k) fourier representation of p(γ)
κ covariance matrix of the probability density p(γ)
λ₁, . . . , λ_{N} eigen-values of κ
D diagonal matrix consisting of D=diag(λ₁, . . . , λ_{N})
R orthogonal matrix which diagonalizes κ
q integration variable vector defined by q≡R^{τ}·k
z auxiliary variable vector defined by z≡R^{τ}·G

### DETAILED DESCRIPTION OF ILLUSTRATIVE EMBODIMENTS

The following detailed description of the invention relates directly to the drawings which are part of the specification.

The symbols used within the description are explained at the place of their introduction. The symbols are also summarized in a table at the end of the Brief Description of the Drawings.

The term “list” indicates a matrix of any size and dimension.

In a first embodiment, the invention relates to a method to simulate the influence of production-caused variations on semiconductor layouts.

The inventive method is not limited to the field of semiconductor technologies, but is also suitable in other production processes wherein fluctuating process parameters cause correlated variations of production related target quantities.

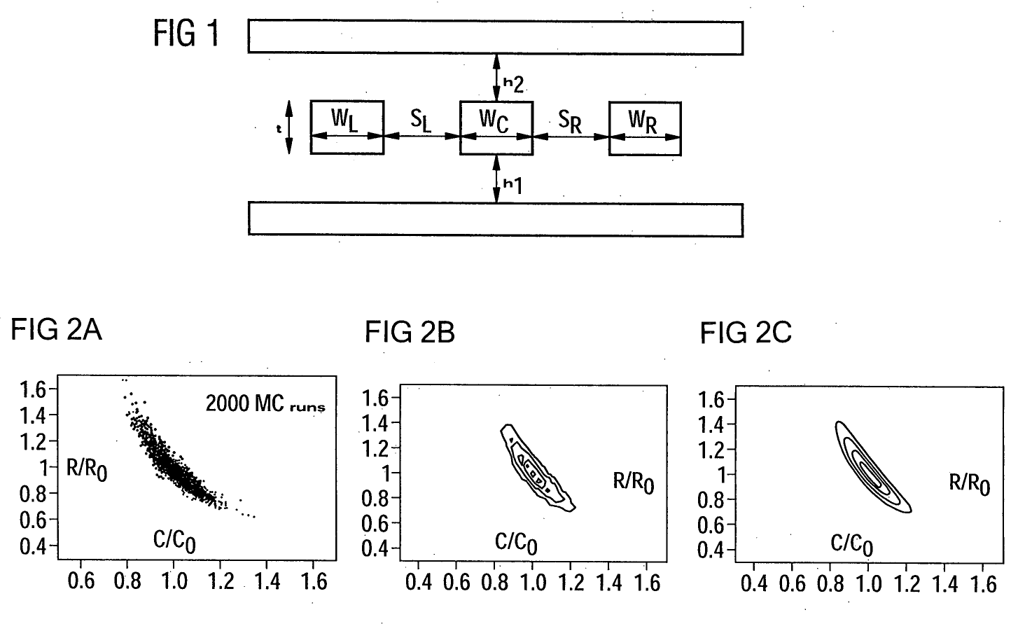

The basic input parameters are the material parameters and the given set of layout data. This data set is grouped to an input-vector x that includes the parameters x₁, . . . , x_{K} denoting the given data, e.g., those physical properties illustrated in FIG. 1. The input parameters are transferred to an extractor. The extractor calculates a list of interconnect parameters Γ from the input parameters. It represents the parasitic properties of the complete interconnect structure (the “nets” which are the interconnections between the semiconductor devices) defined in the given layout. The list calculated from the original, ideal layout and technology data is called “nominal interconnect netlist” and denoted by Γ₀. So far these steps are known in the prior art.

In general, the individual parameters contained in Γ are denoted by g in the following, i.e., the given list contains the parameters g₁, . . . , g_{N} which are a function of the given set of input parameters x, gᵢ=gᵢ(x) (with i=1, . . . ,N).

As further input for the inventive method, the probability distribution of the process variations are known for the input data x₁, . . . , x_{K}. This distribution is denoted by w(x) in the following.

In the iteration step of the inventive method, one of the input values xⱼ (j=1,2, . . . , K) is modified, resulting in a new vector x′ which is stored. The modification is carried out by addition or subtraction of a value Δxⱼ to the original nominal value xⱼ. Since the data will be used to model the behavior of the interconnect properties in the typical fluctuation range of the input parameters, it is advantageous for the inventive method if the absolute value of Δxⱼ is in the range of the standard deviation σ(xⱼ) encoded in the distribution w(x).

The iteration step is repeated until the modification xⱼ→xⱼ±Δxⱼ has been performed for all input parameters xⱼ (j=1,2, . . . , K). Afterwards, n=2K+1 modified input vectors x⁽¹⁾, . . . , x⁽ⁿ⁾ are available. To repeat this step until all n=2k+1 input vectors are generated is ideal but not indicative for the inventive method.

In the next step, all vectors x⁽¹⁾, . . . , x⁽ⁿ⁾ are successively transferred to the extractor as illustrated in FIG. 4. The extractor calculates a corresponding set of lists of interconnect parameters Γ₁, . . . , Γₙ.

In an alternating configuration of the method, the modified vectors are successively generated and immediately transferred to the extractor.

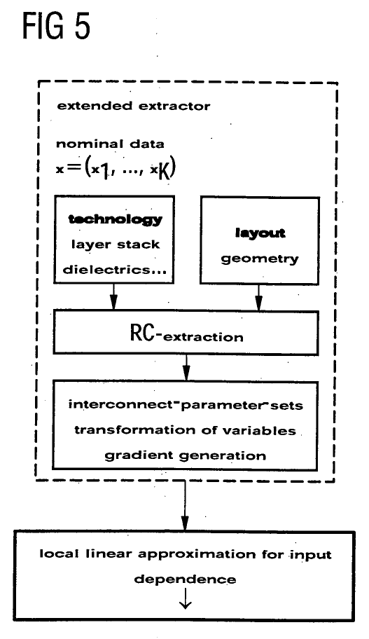

In another alternating configuration of the method, the input-vector modification and the extraction process itself both are performed within the extractor program. This is advantageous since in this case it not necessary to repeatedly generate those parts of the extraction information which are identical for all modified input vectors, thus saving calculation time by reusing the internal extractor data structures. This is illustrated in FIG. 5.

In an advantageous configuration of the inventive method all values g stored in the lists Γₖ (k=1, . . . ,n) are transformed into a set of new values (g₁ . . . , g_{N})→(γ₁, . . . , γ_{N}) by means of an appropriate function φ. The transformed values are denoted by γ, one has γᵢ≡φ(gᵢ) (with i=1,2, . . . , N). The function φ is to be chosen such that one has a unique one-to-one interrelation between g and γ.

This transformation can be a simple normalization step to ease the subsequent treatment, making sure that one has γᵢ=0 for gᵢ=gᵢ⁽⁰⁾ where gᵢ⁽⁰⁾ is the value of gᵢ corresponding to the original nominal interconnect parameters. In this case, it is appropriate to choose a linear function φ defined by

$${γ}_{i} ≡ \frac{{g}_{i}}{{g}_{i}^{( 0 )}} - 1 ( for i = 1 , 2 , … , N )$$

where gᵢ⁽⁰⁾ is the value of gᵢ taken from the list of nominal interconnect parameters.

To also increase accuracy and performance of the method other choices are appropriate.

It is appropriate to choose a logarithmic function φ. It is particularly favorable to choose a transformation function

$${γ}_{i} = {ϕ}_{i} ( {g}_{i} ) = log ( \frac{{g}_{i}}{{g}_{i}^{( 0 )}} ) ( for i = 1 , 2 , … , N ) ,$$

wherein gᵢ⁽⁰⁾ is the value of gᵢ taken from the list of nominal interconnect parameters.

After having performed the transformation step, the resulting lists are denoted by Gₖ instead of Γₖ (with k=1, . . . ,n). In the following, it is assumed that such a transformation has been performed. The lists, therefore, are denoted by Gₖ but the inventive method can also be applied directly without such a transformation.

The lists Gₖ (with k=1, . . . ,n) reflect the dependence of the interconnect parameters on systematic variations with respect to the production parameters encoded in the input vector x. In the inventive method these lists are used to approximately calculate the local gradients of the original interconnect parameters with respect to these parameter variations. They follow from a standard finite difference approximation, e.g. of the form

$$\frac{\partial {γ}_{i}}{\partial {x}_{j}} \approx \frac{{γ}_{i} ( {x}_{j}^{( + )} ) - {γ}_{i} ( {x}_{j}^{( - )} )}{2 Δ {x}_{j}}$$

where xⱼ^{(±)} are the vectors one gets by replacing the single element xⱼ of the original input-vectors by xⱼ±Δxⱼ.

Having calculated these gradients, they are stored as a matrix Ω defined as

$$Ω = {( {Ω}_{ij} )}_{{i = 1 … N}_{j = 1 … K}} = ( \begin{matrix}\frac{\partial {γ}_{1}}{\partial {x}_{1}} & ⋯ & \frac{\partial {γ}_{N}}{\partial {x}_{1}} \\ ⋮ & & ⋮ \\ \frac{\partial {γ}_{1}}{\partial {x}_{K}} & ⋯ & \frac{\partial {γ}_{N}}{\partial {x}_{K}}\end{matrix} ) ,$$

where for the first partial derivative

$$\frac{\partial {γ}_{i}}{\partial {x}_{j}}$$

of the γᵢ with respect to the input parameter xⱼ the approximation discussed before is used.

Using a standard Taylor-expansion, the functions γᵢ can be expanded in a power series around the original nominal value. It is favorable to neglect the nonlinear orders. This leads to the relation

$${{γ}_{i} ( x ) = {\sum }_{j = 1}^{K} \frac{\partial {γ}_{i} ( x )}{\partial {x}_{j}} \vert}_{x = {x}_{0}} ( {x}_{j} - {x}_{j}^{( 0 )} ) .$$

Using a matrix notation shorthand, the same equation can be written as γ(x)=Ω·(x−x₀), where the dot denotes the matrix multiplication.

This relation constitutes an approximation for the behavior of γᵢ(x) in the vicinity of the original input vector x₀ which is of sufficient accuracy in the given range of interest.

In a configuration of the invention, it can be used to generate an arbitrary number of random realizations of the complete configuration of interconnect parameters γᵢ by inserting randomly fluctuating values of the input quantities x. Generating these input quantities using a random number generator which reflects the known distribution w(x) leads to statistically varying values of γᵢ which follow the correct (possibly complicated) distribution of interconnect parameters, including all correlations between these values.

The generated set of random interconnect configurations can be used to simulate the true fluctuations of interconnect parameters which may serve as a base for the decision whether the given layout can be produced with the necessary yield or has to be rejected.

In a further configuration of the invention, the given setup is used to derive an explicit approximation for the probability distribution P(Γ)=P(g₁, . . . , g_{N}) of the interconnect parameters gᵢ or, equivalently, for the probability distribution p(γ)=P(γ₁, . . . , γ_{N}) of the corresponding transformed parameters γᵢ introduced above. This function describes the statistical distribution of the interconnect parameters of the given design induced by the variations of the input parameters. Its explicit form depends on the properties of the known input distribution w(x). For the following steps, one assumes that this input distribution w(x) is a Gauss-distribution.

The distribution p(γ), which defines the probability density for the (transformed) interconnect parameters γ=(γ₁, . . . , γ_{N}) is calculated using the formal relation

$$p ( γ ) = \int ⅆ x \cdot w ( x ) \cdot {\prod }_{i = 1 … N}^{} δ ( {γ}_{i} - {γ}_{i} ( x ) )$$

where γ( . . . ) denotes the usual Dirac delta-distribution.

In a further configuration of the inventive method, the distribution p(γ) is determined using its Fourier transform to simplify the calculation. The Fourier representation \tilde{p}(k) of the distribution p(γ) is given by \tilde{p}(k)=∫d^{N}γexp(+ik^{τ}γ) p(γ), where k^{τ}≡(k₁, . . . , k_{N}) is the (transposed row-) vector of Fourier variables corresponding to the column vector

$$k ≡ ( \begin{matrix}{k}_{1} \\ ⋮ \\ {k}_{N}\end{matrix} ) ,$$

and k^{τ}γ indicates the scalar product between k^{τ} and γ. The corresponding inverse transformation reads

$$p ( γ ) = {\int }_{k} exp ( - ⅈ {k}^{τ} γ ) \tilde{p} ( k )$$

where

$${\int }_{k} …$$

is a shorthand notation for the normalized Fourier-integration

$${\int }_{k}^{} ⋯ ≡ \int \frac{{ⅆ}^{N} k}{{( 2 π )}^{N}} ⋯$$

Inserting the formal relation for the distribution function p(γ) given above into the definition of \tilde{p}(k) and integrating out the Dirac delta-distributions leads to the general relation \tilde{p}(k)=∫d^{K}×w(x) exp(—ik^{τ}γ(x)). If one inserts the above mentioned linear approximation γ(x)=Ω·(x−x₀) for γ(x) one gets accordingly \tilde{p}(k)=∫d^{K}×w(x) exp(−i Ω·(x−x₀)).

The Gaussian distribution w(x) is given explicitly by:

$$w ( x ) = {det ( 2 π Q )}^{- 1 / 2} exp ( - \frac{1}{2} {( x - {x}_{0} )}^{τ} \cdot {Q}^{- 1} \cdot ( x - {x}_{0} ) )$$

where Q is the covariance matrix of the input parameters x₁, . . . , x_{K}. Inserting this expression into the relation for \tilde{p}(k) yields an explicitly solvable Gauss integral. The explicit integration leads to:

$$\tilde{p} ( k ) = exp ( - \frac{1}{2} {k}^{τ} \cdot κ \cdot k )$$

where the covariance matrix κ is given by κ=Ω·Q·Ω^{τ}, where Ω^{τ} is the matrix transposed of Ω. By construction, it is symmetric and positive semi-definite.

The given Fourier transform \tilde{p}(k) again is a Gauss distribution. Its Fourier back-transform is the explicit result for p(γ) of the inventive method. It can be calculated again by performing an explicit Gauss-integration where, however, a careful treatment of possible zero-eigen-values of the covariance matrix κ is necessary. Since κ is symmetrical by construction, there exists an orthogonal matrix R with det(R)=1, and R^{τ}=R⁻¹ such that the matrix κ can be written as κ=R·D·R⁻¹, where R^{τ} is the matrix transposed of R, and R⁻¹ is its inverse, and D is the diagonal matrix D=diag(λ₁, . . . , λ_{N}) consisting of the eigen-values of the matrix K. Without restriction, we assume that the values λ₁, . . . , λ_{N} are ordered according to their size, i.e. λ₁≧λ₂≧ . . . ≧λ_{N}. Since K is positive semi-definite, all eigen-values are positive or zero. To treat the most general case, we assume that we have a number L≦N of strictly positive eigen-values, λ₁≧λ₂≧ . . . ≧λ_{L}>0, and (N−L) eigen-values which are strictly zero, λ_{L}+1=λ_{L}+2= . . . =λ_{N}=0.

With these properties the Fourier back-transformation can be performed explicitly, leading to

$$\begin{matrix}p ( γ ) = {\int }_{k}^{} exp ( - \frac{1}{2} {k}^{τ} \cdot {RDR}^{τ} \cdot k + ⅈ {k}^{τ} \cdot {RR}^{τ} \cdot G ) \\ = {\int }_{q}^{} exp ( - \frac{1}{2} {q}^{τ} \cdot D \cdot q + ⅈ {q}^{τ} \cdot z ) \\ = {\prod }_{l = 1}^{L} {\int }_{{q}_{1}}^{} exp ( - \frac{1}{2} {λ}_{1} {q}_{1}^{2} + ⅈ {q}_{1} {z}_{1} ) {\prod }_{j = L + 1}^{N} {\int }_{{q}_{j}}^{} exp ( ⅈ {q}_{j} {z}_{j} )\end{matrix}$$

where a new integration variable q=R^{τ} k was introduced. Furthermore we exploit that RR^{τ}=1 and define the new variable vector z^{τ}=(z₁, . . . , y_{N}) with z≡R^{τ}·G. The final integrations in the resulting expression can be performed explicitly. One gets

$$p ( γ ) = exp ( - \frac{1}{2} {\sum }_{i = 1}^{L} \frac{{z}_{i}^{2}}{{λ}_{i}^{2}} ) \cdot {\prod }_{j = L + 1}^{N} δ ( {z}_{j} ) .$$

The result is a multivariate Gauss distribution. Mapping the variation of the input parameters to the variation of the interconnect parameters allows important conclusions with respect to the quality of the semiconductor layout.

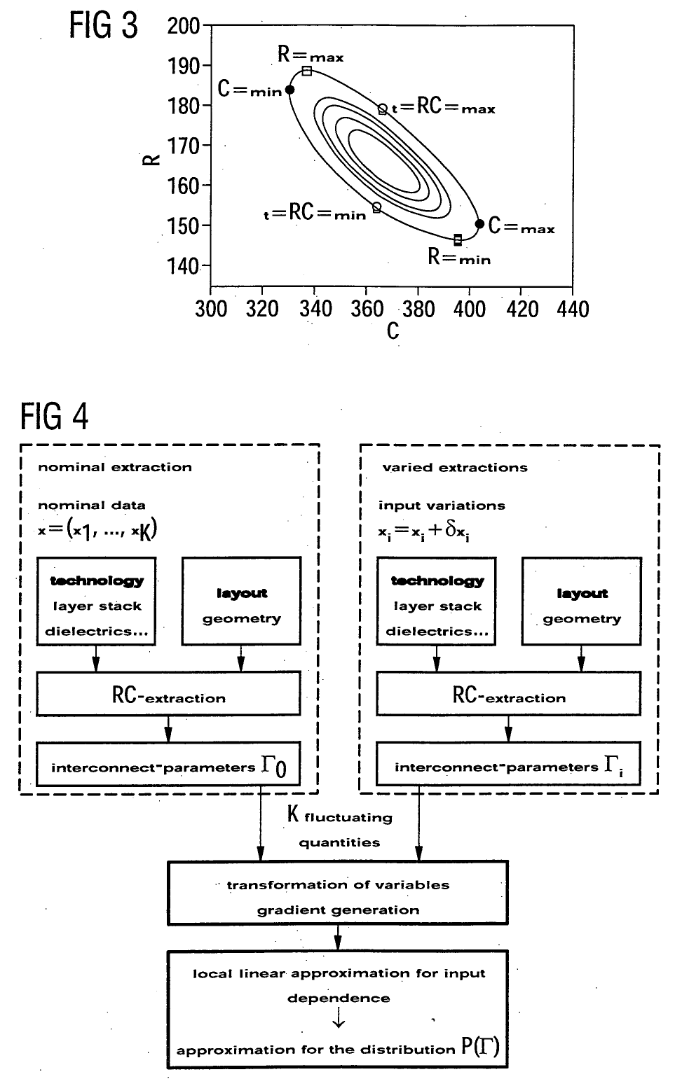

One of the most important applications is to determine the magnitude of production-caused statistical variations of interconnect properties, to derive typical fluctuation ranges of these parameters, and to define representative “corner-configurations” which characterize the boundaries of these ranges. A simple illustration for the case of a bus system with two interconnect parameters (R, C) is given in FIG. 3.

1. A method to simulate the influence of production-caused variations on the electrical interconnect properties of semiconductor layouts, the method comprising:
transferring layout and technology data to a computer implemented extractor in form of a vector x comprising K parameters x₁, . . . , x_{K}, the layout and technology data being related to a layout design;
using the extractor to extract a field Γ₀ of N parasitic values g₁, . . . , g_{N};
generating a vector x⁽¹⁾ comprising parameters x₁⁽¹⁾, . . . , x_{K}⁽¹⁾, wherein some of the values of the vector x⁽¹⁾ represent modifications of values of the vector x that reflect characteristic properties of the probability distribution of the production-caused input variations;
retransferring the vector x⁽¹⁾ to the extractor;
computing a field of modified parasitic values;
repeating the computing until modified fields Γ₁, . . . , Γₙ are available; and
using the modified fields to derive a local approximation for the behavior of the parasitic values gᵢ(x)(for i=1, . . . ,N) as a function of the input parameters.

2. The method according to claim 1, wherein local derivatives
$$\frac{\partial {g}_{i}}{\partial {x}_{j}}$$
(with i=1, . . . ,N, and j=1, . . . ,K) are computed from the set of fields Γ₁, . . . , Γₙ and stored in a field Ω.

3. The method according to claim 2, wherein the local derivatives
$$\frac{\partial {g}_{i}}{\partial {x}_{j}}$$
(with i=1, . . . ,N, and j=1, . . . ,K) are computed within the extractor.

4. The method according to claim 2, wherein a local linear approximation for the behavior of the parasitic values gi(x)(for i=1, . . . ,N) as a function of the input parameters is defined, based on the entries in the field Ω, and this approximation is used to generate sets of representative random configurations of parasitic values by inserting random numbers for x drawn according to the probability distribution w(x) of the production-caused input-parameter variations, and the such generated sets of representative random configurations of parasitic values are used to asses the influence of the process variations on the circuit performance and manufacturability.

5. The method according to claim 1, wherein the parasitic values gi (i=1, . . . ,N) are transformed into a second range of values after extraction by means of a function φ.

6. The method according to claim 5, wherein the function φ is a logarithmic function.

7. The method according to claim 2, wherein a local linear approximation for the behavior of the parasitic values gi(x)(for i=1, . . . ,N) as a function of the input parameters is defined, based on the entries in the field Ω, and this approximation, together with the explicit form of the probability distribution w(x) of input variables, is used to compute the probability distribution P(Γ) of the parasitic values which serves as a basis to asses the influence of the process variations on the circuit performance and manufacturability.
